(19) United States
(12) Patent Application Publication
(10) Pub. No.: US 2008/0215198 A1
(43) Pub. Date: Sep. 4, 2008

(54) METHOD AND APPARATUS FOR PROVIDING TAKEOFF RUNWAY INFORMATION AND PREDICTING END OF RUNWAY OVERRUN

(76) Inventor: Robert E. Richards, Marietta, GA (US)

Correspondence Address: Robert E. Richards, 310 Chase Lane, Marietta, GA, 30068, US

(21) Appl. No.: 11/859,276

(22) Filed: Sep. 21, 2007

Related U.S. Application Data
(60) Provisional application No. 60/846,423, filed on Sep. 22, 2006.

(51) Int. Cl. G01C 21/00; G01S 5/00

(52) U.S. Cl. 701/15; 701/208

(57) ABSTRACT

The present invention discloses a method of providing takeoff runway information. The method includes determining an aircraft's position on an airfield by a global positioning system (“GPS”) receiver in the aircraft and retrieving takeoff runway data from a database based on the aircraft's position as determined by the GPS receiver. Apparatus for practicing the method is also disclosed.

### CROSS-REFERENCE TO RELATED APPLICATIONS

The present application claims the benefit of provisional application Serial No. 60/846,423 filed Sep. 22, 2006 (the disclosure of which is incorporated herein by reference).

### FIELD OF THE INVENTION

The present invention relates to a system for alerting a pilot or flight crew when they are on a runway that is too short for the aircraft to take off safely. More specifically, the present invention relates to a system for determining if an aircraft will reach takeoff speed before it reaches the end of a runway.

### BACKGROUND OF THE INVENTION

On Aug. 27, 2006, Comair Flight 5191 was cleared for takeoff on Runway 22. Runway 22 was a 7,000 foot runway designed for use by commercial aircraft. Inexplicably, however, Flight 5191 turned onto Runway 26, a 3,000 foot runway used by general aviation. The aircraft for Flight 5191 was a Canadair CRJ-100 regional jet, which required approximately 5,000 feet of runway to takeoff based on its load and other conditions that day. The flight crew, however, did not realize that they were on a runway that was 2,000 feet too short for the aircraft to reach sufficient speed to takeoff. Tragically, Flight 5191 barely made it into the air before it crashed through a fence at the end of the runway and then hit a group of trees before bursting into flames and killing 49 people. The aircraft came to rest in a field less than one-half mile from the end of the runway.

If there had been equipment on board Flight 5191 to warn the a pilot or flight crew that they were on a runway too short for their aircraft to takeoff, 49 lives could have been saved. Unfortunately, no such equipment exists.

U.S. Pat. No. 6,614,397 discloses a system for alerting a pilot when he or she is on a wrong runway. This system requires a pilot to manually enter information regarding the correct runway. The system then determines if the aircraft is attempting to takeoff and, using a global positioning system (“GPS”) receiver in the aircraft, determines if the aircraft is more than a certain distance from the centerline of the correct runway. If the aircraft exceed this certain distance during a takeoff attempt, an indication of the wrong runway is provided. This system is unsatisfactory, however, because it requires human action to input the correct runway identification, because it does not provide an indication if the runway is too short and because it cannot detect if an aircraft is performing insufficiently during a ground-roll to reach takeoff speed before reaching the end of the runway.

Therefore, there is a need in the art for an automatic system to alert a pilot or flight crew when they are on a wrong runway; i.e., a system that does not require human action for proper operation. There is also a need for a system to warn pilots when they are on a runway that is too short to takeoff. Furthermore, there is a need in the art for a system that will warn pilots during ground-roll that there is insufficient runway remaining before the aircraft can reach a sufficient speed to takeoff so that the pilots can safely stop the aircraft before overrunning the end of the runway.

### SUMMARY OF THE INVENTION

The present invention solves the foregoing needs by providing a method of providing takeoff runway information. In one disclosed embodiment, the method comprises determining an aircraft's position on an airfield using a global positioning system (“GPS”) receiver in the aircraft, and retrieving takeoff runway data from a database based on the aircraft's position as determined by the GPS receiver.

In another embodiment, the present invention comprises apparatus for providing takeoff runway data based upon the position of an aircraft as determined by a GPS receiver. In a disclosed embodiment, the apparatus comprises a GPS receiver for providing aircraft position data, memory media including a database including takeoff runway data, a processor connected to the GPS receiver and to the memory media; and software for accessing the runway data in the database based upon the aircraft position data provided by the GPS receiver.

In a further embodiment, the runway data stored in the database includes coordinates corresponding to the opposite end of a runway. In yet another embodiment, the processor can determine the distance between the aircraft's position and the opposite end of the runway.

In another embodiment, the processor can compare the distance to the opposite end of the runway, or the time for the aircraft to reach the opposite end of the runway, to the distance needed for the aircraft to reach takeoff speed, or to the time needed for the aircraft to reach takeoff speed. If the distance or time to reach the end of the runway is less than the distance or time for the aircraft to reach takeoff speed, the processor will provide a warning to the pilot or flight crew. In a preferred embodiment, the warning is provided to the pilot or flight crew at a time such that the plane can be stopped safely without overrunning the end of the runway. In an especially preferred embodiment, the processor determines the distance or time to reach the end of the runway based on data from at least one sensor, including, but not limited to aircraft total weight, airfield altitude, density altitude, ambient temperature, relative humidity, runway slope, wind, and aircraft airspeed. In another preferred embodiment, the processor updates the distance or time to reach the end of the runway based on performance characteristics of the aircraft during ground-roll, such as acceleration. The actual acceleration profile is determined based on changes in aircraft GPS position over successive periods of time. Such real-time information allows the processor to detect flaws in takeoff performance and determine whether the aircraft will be able to reach takeoff speed before it reaches the end of the runway. This system provides a great safety feature for aircraft that can save lives and prevent costly aircraft damage or loss.

These and other objects, features and advantages of the present invention will become apparent after a review of the following detailed description of the disclosed embodiments and the appended, drawing and claims.

### BRIEF DESCRIPTION OF THE DRAWING

FIG. 1 is a schematic diagram of a disclosed embodiment of runway information apparatus in accordance with the present invention.

FIG. 2 is a flow chart of a disclosed embodiment of a method of operating the apparatus disclosed in FIG. 1 in accordance with the present invention.

FIG. 3 is a schematic plan view of an aircraft on a runway.

FIG. 4 is a graph of the distance versus airspeed for an aircraft under different performance conditions.

FIG. 5 is a flow chart of an alternate disclosed embodiment of a method of operating the apparatus disclosed in FIG. 1 in accordance with the present invention.

### DETAILED DESCRIPTION OF THE DISCLOSED EMBODIMENTS

In modern aviation, determining whether an aircraft is able to takeoff from a designated runway is left mostly to the experience and judgment of the pilot or flight drew. Although a pilot can calculate the approximate distance that the aircraft must travel on the ground (i.e., the ground-roll) in order to achieve sufficient airspeed to takeoff, the likelihood that an aircraft will actually reach such speed before it runs out of runway is an educated guess based on some crude indications of the amount of runway remaining, such as marking on the runway. In a typical cockpit situation, a first officer will monitor the air speed indicator and will announce to the pilot when the aircraft has achieved the takeoff decision speed (i.e., V1) for the configuration of the aircraft. Based on the pilot's experience, and his view out the cockpit window, a pilot then will have to decide whether to commit the aircraft to takeoff or whether to attempt to stop the aircraft before it runs out of runway. This is not a scientific or a highly accurate system. Furthermore, it relies on human judgment, which can sometimes be impaired or inaccurate.

The present invention is designed to provide the pilot with highly accurate real-time information regarding whether the aircraft will be able to reach takeoff speed (i.e., V2) before it runs out of runway. This information is preferably provided to the pilot while the aircraft still has sufficient runway remaining within which to stop safely. The system of the present invention does not rely on human action or pilot experience or judgment to function properly. It is therefore believed that the present invention achieves a degree of safety never before possible in modern aviation.

A successful takeoff consists of three elements: (1) the ground-roll, (2) the transition distance, and (3) the climbout distance over an obstacle. The present invention addresses all three of these elements of a takeoff and provides the pilot with real-time information regarding the ability of the aircraft to make a successful takeoff.

It is further believed that the present invention can detect certain anomalies in aircraft takeoff performance, such as improperly set flaps, overweight conditions, ground icing and the like, that may result in an extended ground-roll to takeoff speed (V2) and might result in an overrun of the end of the runway.

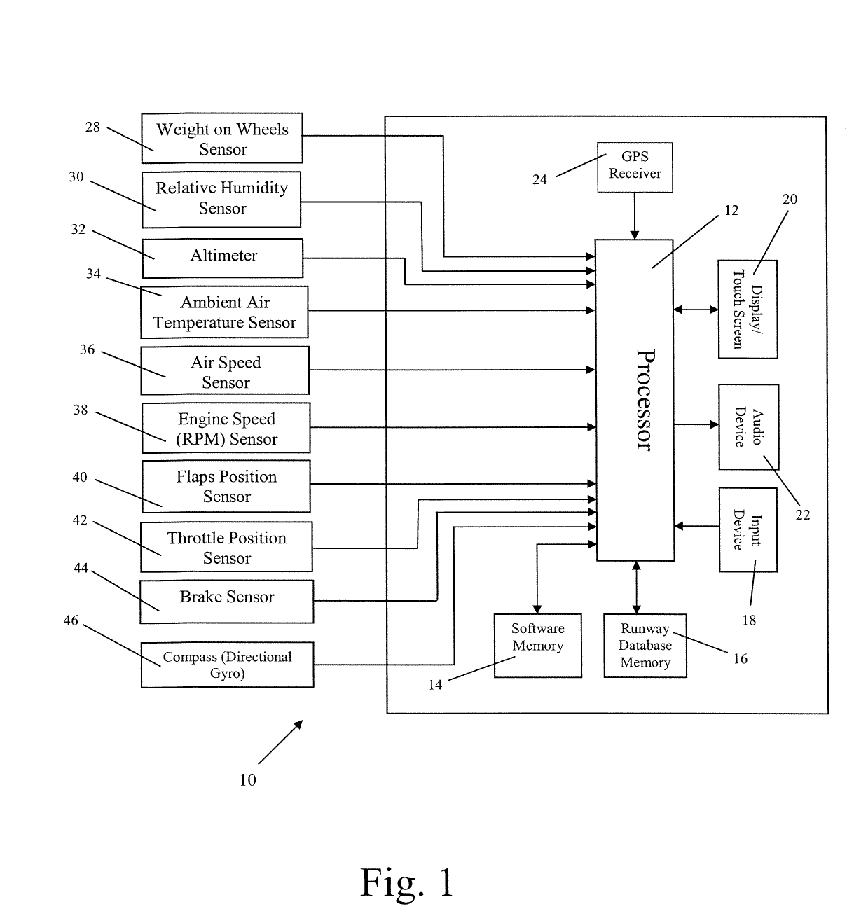

With reference to the drawing in which like numbers indicate like elements throughout the several views, it will be seen that there is disclosed (FIG. 1) an apparatus 10 for providing runway information. The apparatus 10 comprises a computer processor 12 connected to a memory device 14 for storing machine instructions; i.e., computer software, that controls the operation of the processor. The memory device 14 is any device typically used for storing machine instructions including, but not limited to, random access memory (“RAM”), read only memory (“ROM”), programmable read only memory (“PROM”), electronically programmable read only memory (“EPROM”), hard disk, flash memory, and the like. Since it is desirable to both read and write data to the memory device 14, it is preferred that the memory device have both read and write capability.

The apparatus 10 also includes a second memory device 16 connected to the processor 12. The memory device 16 stores a database configured to be accessible by the processor 12. The memory device 16 is any device typically used for storing database information including, but not limited to, random access memory (“RAM”), read only memory (“ROM”), programmable read only memory (“PROM”), electronically programmable read only memory (“EPROM”), hard disk, flash memory, compact disc (“CD”), digital video disc (“DVD”), and the like. The database stored in the memory device 16 contains information about runways at airports throughout a geographic area, such as the United States or Worldwide. The specific information stored in the runway database will be discussed further below.

The apparatus 10 further comprises an input device 18, such as a keyboard, keypad, selector buttons, or the like, connected to the processor 12. The processor 12 is also connected to a display device 20, an audio device 22 or both.

The display device 20 is a device for displaying visual information and/or alphanumeric text, such as a cathode ray tube (“CRT”), a liquid crystal display (“LCD”), a plasma display, one or more lights, or the like. The display device 20 is preferably an LCD touch screen. In an especially preferred embodiment, the display device 20 is part of a flight management system (“FMS”), such as disclosed in U.S. Pat. Nos. 7,098,809; 7,003,383; and 6,952,630 (the disclosures of which are all incorporated herein by reference). If the display device 20 is a touch screen, it can be used in place of the input device 18, or in combination therewith. The display device 20 is configured to display information provided by the processor 12.

The audio device 22 includes, but is not limited to, a speaker, a buzzer, a bell or other like devices. The audio device 22 is configured to provide audible information to the pilot, including, but not limited to speech, sounds, tones, buzzing sounds, bells, or the like.

The apparatus 10 also comprises a global positioning system (“GPS”) receiver 24 connected to the processor 12. As used herein the term GPS receiver means any system that is configured to receive a plurality of satellite signals for determining terrestrial coordinates that establish the position of the receiver, such as longitude and latitude values, whether the system is accessible by civilians, military or both and whether it is accessible in the United States or in a foreign country. In addition to coordinates for locating the position of the receiver, the GPS receiver 24 can also provide altitude data and directional data. GPS receivers having these capabilities are well known in the avionics art, such as those disclosed in U.S. Pat. Nos. 6,477,449; 6,614,397; and 6,801,158 (the disclosures of which are all incorporated herein by reference).

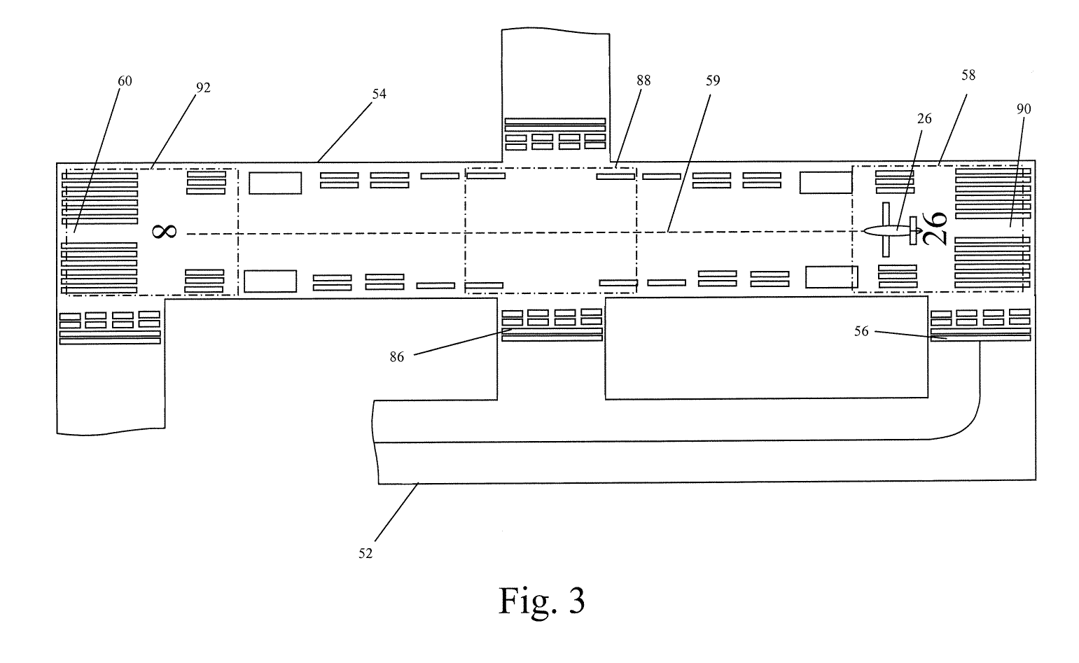

The apparatus 10 is disposed in an aircraft 26 (FIG. 3). Preferably, the display device 20 and the input device 18 are mounted in the cockpit control panel (not shown) for easy access by the flight crew of the aircraft 26. The GPS receiver 24 is connected to an antenna (not shown) mounted on the exterior of the aircraft 26 or in the raydome (nose) of the aircraft so that it can receive signals from earth orbiting satellites in a manner well known in the art.

The foregoing elements 12-24 make up a basic disclosed embodiment of the present invention. When using the basic disclosed embodiment of the present invention, some tasks may need to be performed manually and the results entered into the processor 12 using the input device 18 or the touch screen 20. Therefore, it is preferred, but not necessary, that an alternate disclosed embodiment of the present invention includes a plurality of sensors connected to the processor 12, which provide digital data for several parameters for calculating or determining aircraft performance, such as takeoff ground-roll distance, V1, VR, V2, air speed, and directional information (heading).

Accordingly, in a preferred embodiment, the apparatus 10 also includes one or more of the following: a weight on wheels (“WOW”) sensor 28, a relative humidity sensor 30, an altitude sensor (altimeter) 32, an exterior ambient air temperature sensor 34, an air speed sensor 36, an engine speed sensor (tachometer) 38, a flaps position sensor 40, a throttle position sensor 42, a brake sensor 44 and a compass (directional gyro) 46. In an especially preferred embodiment, the apparatus 10 includes all of the foregoing sensors 28-46. Each of the sensors 28-46 is connected to the processor 12 for providing thereto digital data regarding its corresponding parameter which is measured, determined or detected by the sensor and/or associated hardware and/or software.

The weight on wheels sensor 28 provides the processor 12 with a digital indication of whether weight is applied to the landing gear (not shown) of the aircraft 26 so as to provide an indication of whether the aircraft has left the runway; i.e., whether the aircraft is parked, taxiing or performing a ground-roll or whether the aircraft has taken off; i.e., the landing gear is no longer touching the runway.

The relative humidity sensor 30 provides the processor 12 with digital data regarding the relative humidity of the air outside the aircraft 26. Relative humidity information is useful for determining the power producing capacity of the aircraft engines, which affects the takeoff performance of the aircraft 26. Relative humidity can also be used to determine the takeoff performance of the aircraft 26, since humid air increases the effective density altitude, and may be used in calculating density altitude, such as by using dew point data.

The pressure altimeter 32 provides the processor 12 with digital data regarding the altitude above sea level of the aircraft 26. Although the GPS receiver 24 also provides the processor 12 with digital data regarding the altitude of the aircraft 26, it is desirable to have an altimeter 32 provide this information, as well. Altitude information is useful for determining density altitude, which affects the takeoff performance of the aircraft 26. It is typically for an altimeter have a knob or other setting device for setting the altimeter to the appropriate barometric pressure or barometric altitude. It is preferred that digital data regarding this altimeter setting (barometric pressure setting) be provided to the processor 12, also.

The exterior ambient air temperature sensor 34 provides the processor 12 with digital data regarding the temperature of the air outside the aircraft 26. Air temperature information is necessary for determining the density altitude, which affects the takeoff performance of the aircraft 26.

The air speed sensor 36 or more specifically the air speed indicator provides the processor 12 with digital data regarding the air speed of the aircraft 26. This information is necessary for determining when and/or whether the aircraft 26 has reached or will reach V1, VR or V2.

The engine speed sensor 38 provides the processor 12 with digital data regarding the speed; e.g., revolutions per minute (“RPM”), at which the engine is or engines are running, which corresponds to thrust, and, therefore, the potential of the aircraft 26 to accelerate; such as whether there is sufficient thrust to accelerate to V1, VR or V2.

The flaps position sensor 40 provides the processor 12 with digital data regarding the position of the flaps on the aircraft 26. The position of the flaps affects the speed at which the aircraft 26 can takeoff. The position of the flaps also affects the amount of drag experienced by the aircraft 26, and, therefore, affects the potential of the aircraft 26 to accelerate; such as whether there is too much drag to accelerate to V1, VR or V2 or whether there is sufficient lift to takeoff at a lower airspeed, or takeoff with a shorter ground-roll.

The throttle position sensor 42 provides the processor 12 with digital data regarding the position of the throttle. The position of the throttle provides the processor 12 with information regarding the percentage of full power at which the pilot has set the engines to run, and, therefore, whether the engines are set to run at full speed or whether they are set at less than full speed. This information allows the processor to determine whether the speed of the engines can be increased to thereby increase thrust to accomplish a successful takeoff.

The brake sensor 44 provides the processor 12 with digital data regarding whether the brakes on the wheels of the aircraft are set. Whether the brakes are set affects the potential of the aircraft 26 to accelerate to V1, VR or V2. It also provides an indication of whether the aircraft may be attempting to takeoff.

The compass (directional gyro) 46 provides the processor 12 with digital data regarding the direction in which the aircraft 26 is pointed or traveling; i.e., the heading. Although the GPS receiver 24 provides the processor with digital data regarding the direction of travel of the aircraft 26, it is desirable to have a directional gyro 46 provide this information, also. The heading of the aircraft 26 is useful for determining which runway the aircraft is on when takeoff is initiated.

Operation of the basic embodiment of the apparatus 10 will now be considered. In it simplest form, the basic embodiment of the apparatus 10 uses only the total weight of the aircraft 12 and the density altitude to calculate takeoff airspeed; i.e., V2. Total aircraft weight includes the weight of the aircraft empty plus the weight of fuel, passengers, crew and/or cargo. Density altitude is an indication of how dense the air is based on altitude (i.e.; elevation above sea level), air temperature, and altimeter setting (i.e.; pressure altitude). These parameters are routinely calculated by the flight crew of an aircraft prior to takeoff. These calculations can be performed manually, but more typically are performed using a computer or calculator. It is especially preferred that the density altitude and the total weight of the aircraft can be obtained through a connection between the processor 12 and a FMS. Therefore, the FMS and the apparatus 10 can share data without reentering it. More particularly, it is contemplated that the processor 12 can be a part of an FMS.

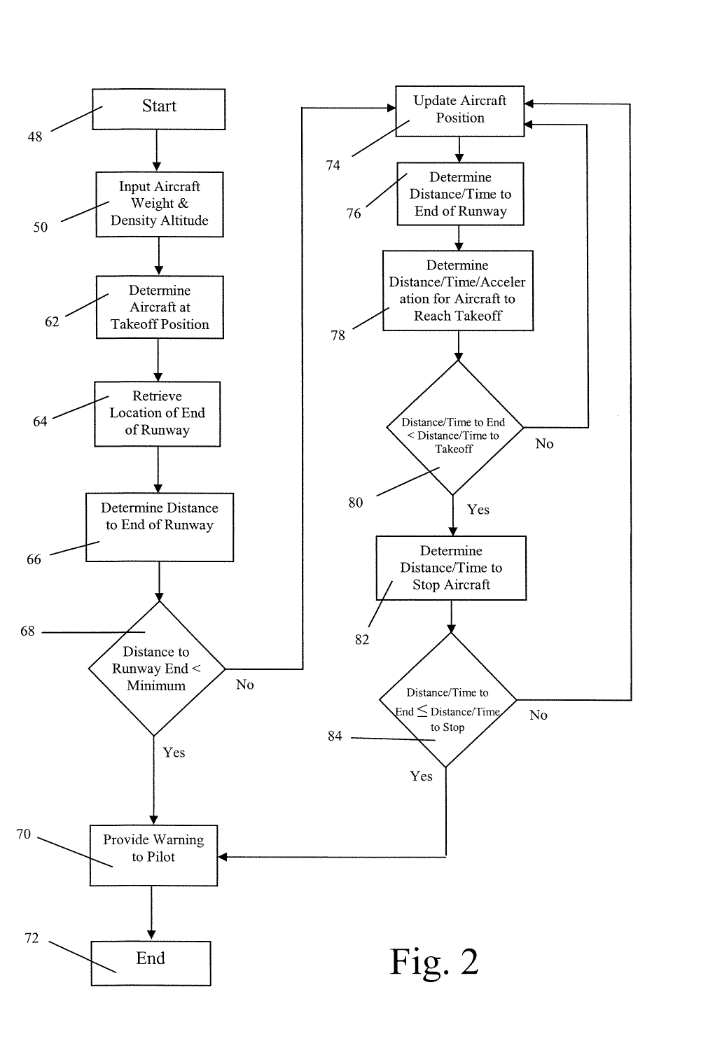

When the apparatus 10 is turned on, the process performed thereby begins at the block 48 (FIG. 2) labeled “Start.” This disclosure assumes that the flight crew has performed the appropriate initialization of the GPS receiver 24, so that it is properly providing the current location of the aircraft 26. This procedure is usually performed by the flight crew at the gate prior to pushback.

The total weight of the aircraft 26 is entered into the apparatus 10 using the input device 18 or the touch screen 20, as shown at the block 50 (FIG. 2) labeled “Input Aircraft Weight & Density Altitude.” The density altitude can then be calculated on a separate calculator device or the individual parameters of altitude, air temperature, altimeter setting and relative humidity (dew point) can be entered into the apparatus 10 using the input device 18 or the touch screen 20, also at the block 50 (FIG. 2). Software stored in the memory device 14 causes the processor 12 to provide prompts on the touch screen 20 for each of the foregoing parameter. In response to these prompts, the flight crew can enter each one of these parameters of total aircraft weight and density altitude (i.e.; altitude, air temperature, altimeter setting and relative humidity) into the processor 12 using the input device 18 or the touch screen 20. This operation is usually performed in preflight preparation or at the gate prior to pushback. The values for total aircraft weigh and density altitude are then stored in the memory device 14 for later use by software also stored in the memory device 14. Alternately, the processor 12 can retrieve the total aircraft weight and density altitude data from the FMS. The headwind component, or H, for the intended runway for takeoff is also calculated and entered into the memory device 14, either using the input device 18, or it is retrieved from the FMS.

The processor 12 uses the values of total aircraft weight and density altitude stored in the memory device 14 to calculate the speeds V1, VR and V2 or to determine them from a lookup table for the specific type of aircraft. These values of V1, VR and V2 are then stored in the memory device 14 for later use. Software for performing the calculation of the speeds V1, VR and V2 or for determining them from a lookup table is known in the art.

As the aircraft 26 is taxiing on the taxiway 52 to the active runway 54 (FIG. 3), the GPS receiver 24 receives signals from a plurality of satellites orbiting the earth and uses those signals to determine the position of the aircraft on the taxiway, such as by providing the coordinates, such as longitude and latitude, of the aircraft's position to the processor 12. The GPS receiver 24 also optionally provides to the processor 12 data corresponding to the direction in which the airplane is pointed (i.e., heading) and the altitude (above sea level) of the airplane.

The processor 12 uses the data provided by the GPS receiver 24 to determine when the aircraft 26 enters or is positioned at a runway takeoff position. This is accomplished by comparing the coordinates of the position of the aircraft 26, as provided by the GPS receiver 23, to coordinates of the takeoff positions for runways at various airport for a given geographic area, such as for the United States or the World, stored in a runway database stored in the memory device 16. As shown in FIG. 3, the runway 54 has three potential positions from which an aircraft can attempt to takeoff. For an aircraft given clearance to takeoff from “Runway 26,” the aircraft 26 enters the runway 54 from the hold position 56 and is shown properly positioned at the runway takeoff position in FIG. 3. Runway takeoff positions are defined in the database by storing a range of longitude and latitude values that define a geometric area at the takeoff position on runway 54, such as the rectangle 58. Alternately, the coordinates of a single point can be used and a given radius used to define the geometric area. Still another way would be to use the coordinates of the centerline 59 of the runway 54 and define the geometric area as a given distance on either side of the centerline. Therefore, when the coordinates of an aircraft's position correspond to, or fall within the, takeoff position coordinates that are stored in the runway database, which is stored in the memory device 16, the corresponding database record is retrieved and that data is stored in the memory device 14.

In addition to including the coordinates of runway takeoff positions, the runway database also includes the coordinates of the corresponding opposite end of the runway. Therefore, the runway database record corresponding to the takeoff position 58 also includes the coordinates of the opposite end 60 of the runway 54 (FIG. 3). Accordingly, when the aircraft 26 enters the runway takeoff position 58, the coordinates provided to the processor 12 by the GPS receiver 24 fall within the range of longitude and latitude coordinates of the runway takeoff position 58 stored in the runway database. This process step is shown at the block 62 labeled “Determine Aircraft at Takeoff Position” (FIG. 2). When it is determined that the coordinates of the aircraft's position fall within the range of the coordinates of the runway takeoff position 58, the processor 12 retrieves the corresponding database record from the memory device 16 and the data from that record is stored in the processor memory 14, including the coordinates of the opposite end 60 of the runway 54. This process step is shown at the block 64 labeled “Retrieve Location of End of Runway” (FIG. 2). Therefore, the processor 12 can access the data stored in the memory device 14 corresponding to the current aircraft 26 position and the opposite end 60 of the runway 54.

In a preferred embodiment of the present invention, in addition to including the coordinates of the runway takeoff positions and the coordinates of the opposite end of the runway, the runway database also includes the heading or designation of the runway. When it is determined that the coordinates of the aircraft's position fall within the range of the coordinates of the runway takeoff position 58, the processor 12 retrieves the database record from the memory 16 and the data from that record is stored in the processor memory 14, as described above, including the heading or designation of the runway. Therefore, the processor 12 can access the data stored in the memory 16 corresponding to the aircraft's current position on the runway 54, and determine the coordinates of the opposite end 60 of the runway 54 and the runway heading or designation, which in this case is “Runway 26.” Thus, when it is determined that the coordinates of the aircraft's position fall within the range of the coordinates of the runway takeoff position 58, the apparatus 10 will provide the fight crew with an indication of the runway heading or designation. This indication can be provided by the processor 12 causing the display device 20 to display the text “Runway 26” and/or by causing the audio device 22 to providing an audible indication, such as by using a speech synthesizer to speak the word “entering Runway 26.” In an especially preferred embodiment, the text “Runway 26” is displayed on the FMS display.

By accessing the coordinates of the current position of the aircraft 26 and the coordinates of the opposite end 60 of the runway 54, the processor 12, using software stored in the memory 14, can calculate the distance between the current position of the aircraft and the end 60 of the runway 54 in real-time and store that distance in the memory 14. This process step is shown at the block 66 labeled “Determine Distance to End of Runway” (FIG. 2). The calculation of the distance between two sets of coordinates (e.g., longitude and latitude or coordinates corresponding to longitude and latitude) is known in the art, and the software therefor, is within the level of skill of those of ordinary skill in the art, and, therefore, is not set out here. This initial distance between the aircraft 26 and the end 60 of the runway 54, or D_{R}, is stored in the memory device 14. The distance D_{R} can also be displayed on the display device 20.

It is contemplated that the apparatus 10 is customized for the aircraft in which it is installed and the minimum runway length for that specific type of aircraft, or Dₘᵢₙ, is stored in the memory device 14. Alternately, it is contemplated that in an initial setup routine for the apparatus 10, the type of aircraft is entered into the memory device 14 and the corresponding minimum runway length, or Dₘᵢₙ, is retrieved from a lookup table and stored in the memory device 14. Either way, during operation of the apparatus 10, the Dₘᵢₙ for the aircraft 26 is stored in the memory 14. After the apparatus 10 has performed the initial calculation of the distance between the aircraft 26 and the end 60 of the runway 54 to determine D_{R}, the processor 12 compares the distance between the aircraft 26 and the end 60 of the runway 54 to the minimum runway length stored in the memory 14. This process step is shown at the block 68 labeled “Distance to Runway End<Minimum” (FIG. 2).

If the distance between the aircraft 26 and the end 60 of the runway 54 is less than the minimum runway length; or D_{R}<Dₘᵢₙ, the processor 12 will provide a visual warning to the flight crew by causing text to be displayed on the display device 20 and/or by providing an audible warning on the audio device 22. The warning may be, for example, the text “Runway Too Short—Abort Takeoff” on the display device 20 or a speech synthesizer can provide the words “Runway Too Short—Abort Takeoff” on the audio device 22. This process step is shown at the block 70 labeled “Provide Warning to Pilot” (FIG. 2).

The process is then ended at block 72 labeled “End” (FIG. 2). If the distance between the aircraft 26 and the end 60 of the runway 54 is not less than the minimum runway length, the processor 12 will continue the process at block 74.

At block 74, the GPS receiver 24 provides the current coordinates of the aircraft's position to the processor 12. The aircraft's current position, or P_{cur}, is continuously updated and is stored in memory 14 for later use, such as P_{cur1}, P_{cur2}, etc. The time of each of the readings of the current position is also stored in the memory device 14. Thus, P_{cur1} and its corresponding time, or T₁, are stored in the memory device 14 and P_{cur2} and its corresponding time, or T₂, are also stored in the memory device 14. If the aircraft 26 is still positioned at the takeoff position 58, the aircraft's current position, as provided by the GPS receiver 24 to the processor 12, will not change. However, if the aircraft 26 begins its ground-roll, the aircraft's position, as provided by the GPS receiver 24 to the processor 12, will change. In either case, the aircraft's current position is updated at the block 74. This information is stored in the memory 14 for later use.

The coordinates of the opposite end 60 of the runway 54 were previously stored in the memory device 14 from the process at block 64. Thus, by accessing the coordinates of the updated aircraft's current position (P_{cur}) and the coordinates of the opposite end 60 of the runway 54, the processor 12, using software stored in the memory 14, can calculate the distance between the updated current position of the aircraft 26 and the end of the runway in real-time and store that distance (D_{R} or distance remaining) in the memory 14. This process step is shown at the block 76 labeled “Determine Distance/Time to End of Runway” (FIG. 2). As stated above, the calculation of the distance between two sets of coordinates (e.g., longitude and latitude or coordinates corresponding to longitude and latitude) is known in the art, and the software therefor, is within the level of skill of those of ordinary skill in the art, and, therefore, is not set out here. This distance D_{R} is stored in the memory 14 for later use.

The time for the aircraft 26 to reach the end 60 of the runway 54, or t_{end}, is also calculated based on current ground speed and current acceleration, which can be calculated from coordinate data provided by the GPS receiver 24. The current ground speed of the aircraft 26, or S_{g}, can be calculated from the change in position of the aircraft, such as (ΔP_{cur}) or (ΔD_{R}), as determined by the GPS receiver 24, as a function of time. Change in position is calculated by subtracting P_{cur1} from P_{cur2}; the elapsed time between those positions is calculated by subtracting T₁ from T₂. If D is the distance from one position of the aircraft 26 to another and T is time for the aircraft to travel from that one position to the other, the speed of the aircraft can be determined by solving the equations S_{g}=D/T.

The acceleration of the aircraft 26 is calculated from the change in ground speed of the aircraft as a function of time. If S_{g} is the aircraft's ground speed, the current acceleration of the aircraft 26 can be calculated by solving the equation a_{cur}=dS_{g}/dT, where a_{cur} is the current acceleration of the aircraft, dS_{g} is the change in ground speed, and dT is the change in time.

The time for the aircraft 26 to travel the distance between the updated position of the aircraft 26 and the end 60 of the runway 54 can be calculated from the equation D_{R}=S_{g}t_{end}+0.5 a_{cur}t_{end}, where t_{end} is the time for the aircraft to reach the end 60 of the runway 54, D_{R} is the distance remaining between the aircraft and the end of the runway, a_{cur} is the current acceleration of the aircraft and S_{g} is the current ground speed of the aircraft. Converting this equation to a quadratic equation and solving for t_{end} provides the time to reach the end of the runway at an initial speed of S_{g} and a constant acceleration of a_{cur} or

t_{end}=−(Sg/a_{cur})±[(2Sg/a_{cur})²+(2D_{R}/a_{cur})]^{0.5}

Alternately, the acceleration necessary for the aircraft 26 to reach takeoff air speed (V2) can be calculated as a_{need}=[V(f)²×V(i)²]/D_{R}², where V(f) is the final velocity or takeoff speed (V2), V(i) is the current ground speed of the aircraft, and D_{R} is the distance between the aircraft and the end 60 of the runway 54. Substituting known values for this equation yields a_{need}=[V2²×(S_{g}+H)²]/D_{R}², where aₙ is the acceleration needed for the aircraft to reach takeoff air speed, V2 is takeoff air speed, S_{g} is the current ground speed, H is the headwind component of the current wind conditions, and D_{R} is the distance remaining between the aircraft and the end of the runway.

The time needed for the aircraft 26 to reach V2 can be calculated from the following equation t_{need}=[V2−(Sg+H)]/a_{cur}, where Sg is the current ground speed, H is the headwind component of the current wind conditions, and a_{cur} is the current acceleration, as computed from the GPS receiver position data. The distance needed to reach V2 can be calculated from the equation D_{need}=t_{need}[Sg+(Sg+(a_{cur}*t_{need})]/2. All of these values; i.e., V2, D_{need}, D_{R}, S_{g}, t_{end}, t_{need}, a_{cur} and a_{need}, are stored in the memory 14. Thus, the time, distance and/or acceleration necessary for the aircraft to reach takeoff speed is determined at block 78.

Of the foregoing values stored in memory 14, the most direct approach to calculating whether the aircraft will reach takeoff speed before the available runway runs out is a comparison of t_{need} and t_{end}; i.e., whether the time for the aircraft to reach the end of the runway is less than the time needed to reach V2. This comparison can be performed by the processor 12 by retrieving the values of t_{need} and t_{end} from the memory 14 and, using appropriate processor instructions, to compare those values. This process is performed at block 80 entitled “Distance/Time to End<Distance/Time to Takeoff” (FIG. 2). If the time within which the aircraft 26 will reach the end 60 of the runway 54 is less than the time needed for the aircraft to reach V2, i.e.; if t_{end} is less than t_{need}, the process is transferred to block 82, which is entitled “Determine Distance/Time to Stop Aircraft.”The distance and/or time necessary to stop the aircraft 26 at it's current speed is then calculated by the processor 12. For a given type of aircraft, the braking deceleration performance (i.e., maximum brake application plus thrust reversers) is stored in the memory device 14 or is determined from a lookup table during an initial setup routine. The same equation for determining time to the end of the runway is used for this calculation, except the braking deceleration is substituted for the current acceleration, or a_{cur}. From this information and the current ground speed of the aircraft, it can be determined how long it will take for the aircraft to come to a safe stop based upon its current speed. The time necessary for the aircraft to stop, or tₛₜₒₚ, is stored in memory 14. The time for the aircraft to reach the end of the runway was calculated in block 78 and stored in the memory 14. Therefore, the processor 12 retrieves from the memory 14 the time necessary for the aircraft to stop, or tₛₜₒₚ, and the time for the aircraft to reach the end of the runway, or t_{end}. Alternately, the processor 12 can determine the distance necessary for the aircraft to stop, based upon its current speed. The distance necessary for the aircraft to stop, or Dₛₜₒₚ, is stored in the memory 14. The distance to the end of the runway was determined at block 78 and stored in the memory 14. Therefore, the processor 12 can retrieve from the memory 14 the distance necessary for the aircraft to stop, or Dₛₜₒₚ, and the distance to the end of the runway, or D_{R}.

The processor 12 then compares either the time necessary for the aircraft to reach the end of the runway to the time necessary for the aircraft to stop or the distance necessary for the aircraft to stop to the distance to the end of the runway. This process is performed at block 84 entitled “Distance/Time to End≦Distance/Time to Stop.” If the time necessary for the aircraft to reach the end of the runway is less than or equal to the time necessary for the aircraft to stop; i.e., t_{end}≦tₛₜₒₚ, the process is transferred to block 70. Block 70 provides a warning to the flight crew, such as “Abort Takeoff—Insufficient Runway Length.” If the time necessary for the aircraft to reach the end of the runway is not less than or equal to the time necessary for the aircraft to stop; i.e., t_{end} is not less than or equal to tₛₜₒₚ, the process is transferred to block 74. Alternately, the comparison at block 84 can be based on distance instead of time. Thus, if the distance remaining to the end of the runway is less than or equal to the distance necessary for the aircraft to stop; i.e., D_{R}≦Dₛₜₒₚ, the process is transferred to block 70 where a warning is given to the flight crew. If the distance remaining to the end of the runway is not less than or equal to the distance necessary for the aircraft to stop; i.e., D_{R} is not less than or equal to Dₛₜₒₚ, the process is transferred to block 74. At block 74, the position of the aircraft is updated and the process steps at blocks 74-84 are repeated.

Another possible position for takeoff on runway 54 is located at its mid-point where the taxiway 52 also provides access thereto. This might be a runway access point used by general aviation, because they would not need the full length of the runway. Also, this position may be a point for crossing the active runway 54. However, a flight crew may mistakenly enter the runway 54 from the hold position 86 thinking that they were at the takeoff position 58, when in fact, they are at takeoff position 88. The range of coordinates for runway position 88 is included in the runway database stored in the memory 16. Therefore, when the aircraft 26 enters the runway position 88, the GPS receiver 24 provides the coordinates of the position of the aircraft to the processor 12, which then retrieves the runway database record corresponding to the takeoff position 88 from the runway database in the memory 16 and the data from that record is stored in the processor memory 14, including the coordinates of the opposite end 60 of the runway 54 and the heading or designation of the runway, as previously described with respect to block 64. Since the takeoff position 88 is at the mid-point of the runway 54, takeoff could be attempted in either direction; i.e., on heading “26” or “08”. Therefore, the coordinates of both opposite ends 60, 90 of the runway would be included for the runway database record corresponding to the takeoff position 88. That database record would also contain as the heading or designation for the runway 54 both headings or designations; i.e., both “Runway 26” and “Runway 08.” Therefore, in order to resolve this ambiguity, the data from the GPS receiver 24 regarding the heading of the aircraft would be used by the processor 12 in order to determine which set of data to use. Accordingly, if the GPS heading of the aircraft 26 at runway position 88 is 260 degrees, or within a few degrees of that heading, machine instructions for the processor 12 would determine that the coordinates for the end 60 of the runway 54 are to be used and that the heading or designation of the runway is “Runway 26.” Thus, when the aircraft 26 enters the takeoff position 88 and turns to a heading of approximately 260 degrees, as determined by the GPS receiver 24, the processor 12 would cause the display device 20 to display the text “Runway 26” and/or cause the audio device 22 to providing an audible indication, such as by using a speech synthesizer to speak the words “Runway 26.” In an especially preferred embodiment, the text “Runway 26” is displayed on the FMS display. If the GPS heading of the aircraft 26 at takeoff position 88 is 080 degrees, or within a few degrees of that heading, machine instructions for the processor 12 determines that the coordinates for the end 90 of the runway 54 are to be used and that the designation of the runway is “Runway 8.” Thus, when the aircraft 26 enters the runway position 88 and turns to a heading of approximately 080 degrees, as determined by the GPS receiver 24, the processor 12 causes the display device 20 to display the text “Runway 8” and/or causes the audio device 22 to providing an audible indication, such as by using a speech synthesizer to speak the words “Runway 8.” In an especially preferred embodiment, the text “Runway 8” is displayed on the FMS display. The apparatus 10 will perform similarly when the aircraft 26 enters the takeoff position 92.

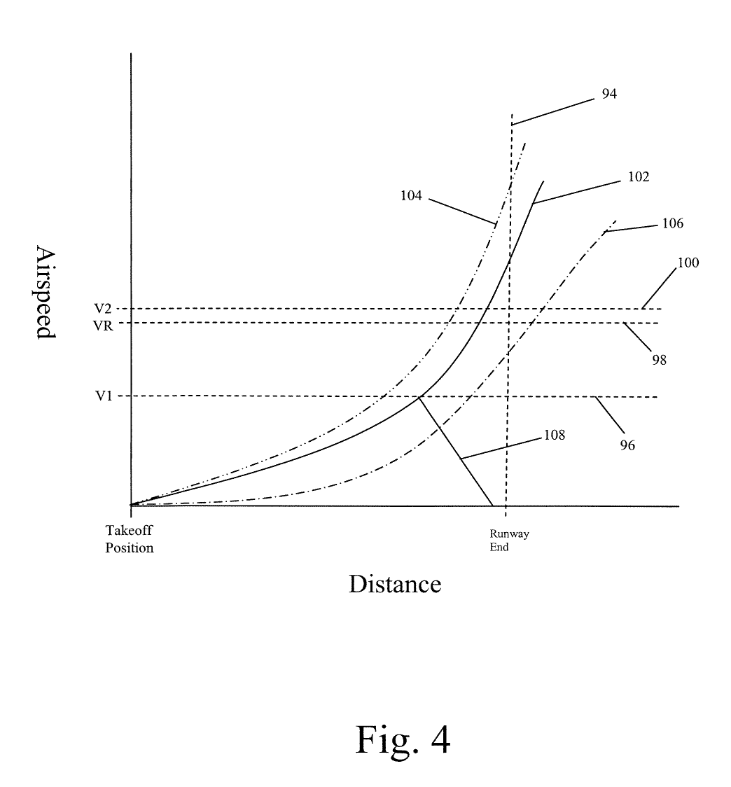

With reference to FIG. 4, there is shown a graph of airspeed versus distance. The origin represents the takeoff position, such as the takeoff position 58, and zero airspeed. The end 60 of the runway 54 is represented by the line 94. The speeds V1, VR and V2 are represented by the lines 96, 98 and 100, respectively. In a preferred embodiment, it is desired that the processor 12 produces a speed vs. distance profile representing the expected takeoff characteristics of the aircraft 26 based upon a plurality of one or more input parameters, such as aircraft total weight, airfield altitude, density altitude, ambient temperature, relative humidity, runway slope, wind, and flap position. This speed vs. distance profile is graphically represented by the curve 102 (FIG. 4). The curve 102 represent the expected speed necessary at any distance from the takeoff position in order to accomplish a safe, normal takeoff; i.e., all systems performing as expected.

The curve 104 represents the plot of speed versus distance data provided by the apparatus 10 for the takeoff of the aircraft 26. It can be seen from a comparison of the curve 104 to the curve 102 that the takeoff performance of the aircraft 26 is better than the nominal expected performance. For the aircraft 26, the speeds V1, VR and V2 were all reached in a shorter distance, as shown by the intersection of the curve 104 and the lines 96-100, than the nominal expected performance, as shown by the intersection of the curve 102 and the lines 96-100. Thus, any combination of speed and distance of the aircraft 26 that corresponds to a point above and to the left of the curve 102 would result in a takeoff of the aircraft before the end 60 of the runway 54 is reached. Conversely, a combination of speed and distance of the aircraft 26 that corresponds to a point below and to the right of the curve 102, such as shown by the curve 106 may not result in a takeoff of the aircraft before the end 60 of the runway 54 is reached. As can be seen from the intersection of the curve 106 and the line 100, the V2 airspeed is not reached until after the end of the runway is reached. Such a condition would result in an overrun of the end of the runway and a likely crash of the aircraft.

It is contemplated in a desired embodiment of the present invention that the apparatus 10 is programmed to prepare a speed vs. distance profile for a normal takeoff, such as represented by the curve 102. For example, for specific input parameters of total aircraft weight and density altitude, a speed vs. distance profile for the aircraft 26 is generated by the processor 12. This profile is produced using an equation or by using a lookup table stored in memory device 16 using appropriate machine instructions for the processor 12. Then, as current speed and distance data is generated by the apparatus 10, as described above, the actual performance of the aircraft 26 during its ground-roll can be compared by the processor 12 to the speed vs. distance profile, such as by comparing actual speed and distance values to nominal values of speed and distance in the lookup table in the memory device 16. Based on such a comparison, the processor 12 determines whether the actual performance of the aircraft 26 is sufficient to achieve takeoff before encountering the end 60 of the runway 54; i.e., whether to actual performance is above and to the left of the curve 102 or whether it is below and to the right of the curve 102. Thus, at any point during the ground-roll of the aircraft 26, if the speed and distance of the aircraft is determined by the processor 12 to correspond to a point below and to the right of the curve 102, the processor will provide a warning to the flight crew, such as by providing appropriate text or graphic display on the display device 20 and/or by providing an audible warning on the audio device 22. The processor 12 also provides a graphical representation of the speed and distance performance of the aircraft 26 compared to the nominal performance, such as by providing a plot similar to the graph shown in FIG. 4 on the display device 20. In an especially preferred embodiment of the present invention, a plot of actual ground-roll performance and nominal ground-roll performance, similar to the graph shown in FIG. 4, is displayed, or overlaid, on the FMS display. The apparatus 10 therefore provides the flight crew with real-time information regarding the actual ground-roll performance of the aircraft.

In addition to determining if an aircraft is attempting to takeoff from the wrong runway, or a runway too short for the aircraft or for the load or other conditions, it is specifically contemplated that the present invention can detect abnormal performance that would result in the aircraft not reaching takeoff speed before encountering the end of the runway. For example, if the aircraft's engines are not producing the proper amount of thrust, the aircraft will not accelerate as quickly as expected. Since the present invention monitors speed, acceleration and distance and/or time to reach takeoff speed and/or the end of the runway, the apparatus 10 can warn the flight crew if the low thrust condition of the engines will result in an overrun of the end of the runway. Similarly, if the aircraft has accumulated ground ice prior to takeoff, the additional weight of the ice will result in the aircraft not accelerating as quickly as otherwise necessary to reach takeoff speed. Again, since the present invention can detect the inability of the aircraft to accelerate to the necessary takeoff speed before encountering the end of the runway, the present invention can provide an early warning to the flight crew of anomalies in aircraft takeoff performance in time to abort the takeoff and safely stop the aircraft.

For example, if the engines of the aircraft 26 were not developing the desired amount of thrust, the aircraft might be performing the ground-roll in a manner represented by the curve 106 (FIG. 4). Since the line 108 represents the deceleration necessary to stop the aircraft before encountering the end 60 of the runway 54, the intersection of the curve 106 and the line 108 is the point at which the takeoff attempt must be aborted in order to safely stop the aircraft without overrunning the end of the runway. Note that the intersection of curve 106 and the line 108 occurs before the aircraft ever reaches V1. Thus, the apparatus 10 is capable of giving the flight crew a warning regarding overrunning the end of the runway before V1 is achieved. Such an early warning increases the odds that the flight crew will be able to safely stop the aircraft without overrunning the end of the runway.

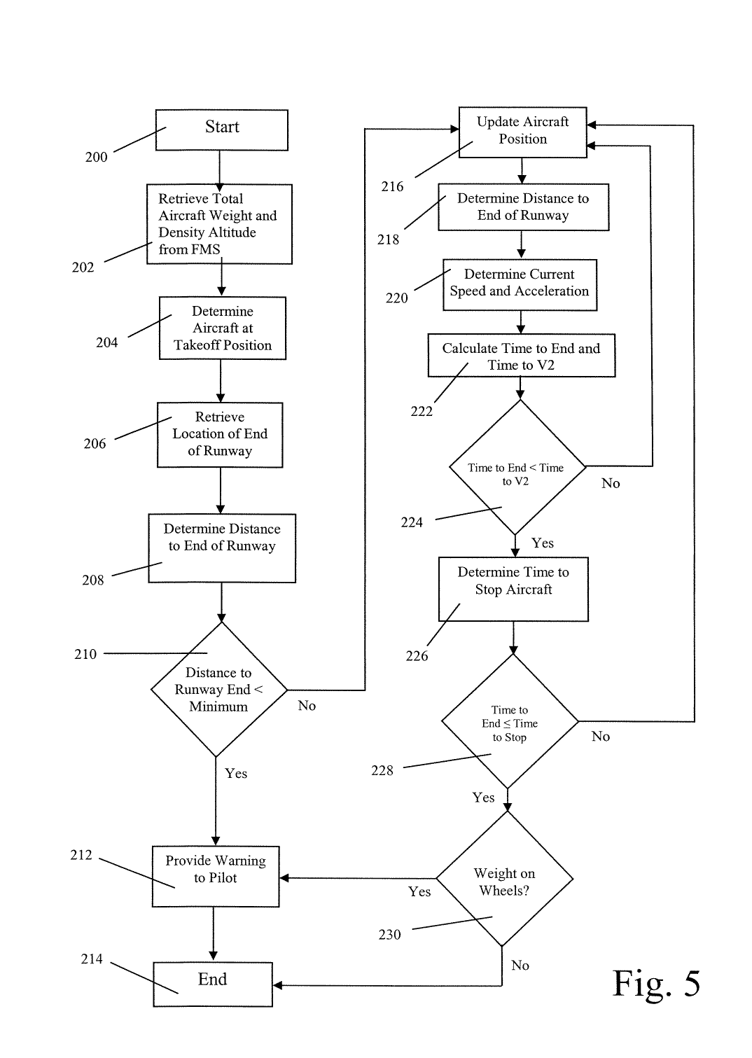

The operation of the apparatus 10 using the inputs from the sensors 28-46 will now be considered. When the apparatus 10 is turned on, the process performed thereby begins at the block 200 (FIG. 5) labeled “Start.” This disclosure assumes that the flight crew has performed the appropriate initialization of the GPS receiver 24, so that it is properly displaying the current location of the aircraft. This procedure is usually performed at the gate prior to pushback.

It is assumed in this embodiment of the invention that the apparatus 10 is connected to the FMS (not shown) of the aircraft 26. Therefore, when the apparatus 10 is operating, it can retrieve the data regarding the total weight of the aircraft and the density altitude from the FMS because those values have been calculated by, or entered into, the FMS and are stored therein. This process step is shown at block 202 entitled “Retrieve Total Aircraft Weight and Density Altitude from FMS.” Alternately, the total weight of the aircraft can be entered using the input device 18 and stored in the memory device 14. The input to the processor 12 from the altimeter 32, including the altimeter setting, the ambient temperature sensor 34 and the relative humidity sensor 30 are used to calculate the value of V2. Software for calculating V2 is known in the art or the value of V2 can be obtained from a lookup table or derived from a graph. Alternately, the value of V2 can be retrieved by the processor 12 from the FMS. However the value of V2 is determined, the value of V2 is stored in the memory device 14 for later use.

As the aircraft 26 is taxiing on the taxiway 52 to the active runway 54 (FIG. 3), the GPS receiver 24 receives signals from a plurality of satellites orbiting the earth and uses those signals to determine the position of the aircraft on the taxiway, such as by providing the coordinates, such as longitude and latitude, of the aircraft's position to the processor 12. The processor 12 uses the data provided by the GPS receiver 24 to determine when the aircraft 26 enters or is positioned at a runway takeoff position. This is accomplished by comparing the coordinates of the position of the aircraft 26 to coordinates of the takeoff positions for runways at various airport for a given geographic area, such as for the United States or the World, stored in the runway database stored in the memory device 16. For an aircraft given clearance to takeoff from “Runway 26,” the aircraft 26 enters the runway 54 from the hold position 56 and is shown properly positioned at the runway takeoff position 58 in FIG. 3. Therefore, when the coordinates of the aircraft's position correspond to, or fall within the, takeoff position coordinates that are stored in the runway database, which is stored in the memory device 16, the corresponding database record is retrieved and the data from that record is stored in the memory device 14.

In addition to including the coordinates of runway takeoff positions, the runway database includes the coordinates of the corresponding opposite end of the runway. Therefore, the runway database record corresponding to the takeoff position 58 also includes the coordinates of the opposite end 60 of runway 54 (FIG. 3). Accordingly, when the aircraft 26 enters the runway takeoff position 58, the coordinates provided to the processor 12 by the GPS receiver 24 fall within the range of longitude and latitude coordinates of the runway takeoff position 58 stored in the runway database. This process step is shown at the block 204 labeled “Determine Aircraft at Takeoff Position” (FIG. 5). When it is determined that the coordinates of the aircraft's position fall within the range of the coordinates of the runway takeoff position 58, the processor 12 retrieves the corresponding database record from the memory 16 and the data from that record is stored in the memory device 14, including the coordinates of the opposite end 60 of the runway 54. This process step is shown at the block 206 labeled “Retrieve Location of End of Runway” (FIG. 5). Therefore, the processor 12 can access the data stored in the memory device 16 corresponding to the current aircraft 26 position and the opposite end 60 of the runway 54.

In addition to including the coordinates of runway takeoff positions and the coordinates of the opposite end of the runway, the runway database also includes the heading of the runway. When it is determined that the coordinates of the aircraft's position fall within the range of the coordinates of the runway takeoff position 58, the processor 12 retrieves the database record from the memory 16 and the data from that record is stored in the processor memory 14, as described above, including the heading or designation of the runway. Therefore, the processor 12 can access the data stored in the memory 16 corresponding to the aircraft's current position on the runway 54, and determine the coordinates of the opposite end 60 of the runway 54 and the runway heading or designation, which in this case is “Runway 26.” Thus, when it is determined that the coordinates of the aircraft's position fall within the range of the coordinates of the runway takeoff position 58, the apparatus 10 will provide the fight crew with an indication of the runway heading or designation. This indication can be provided by the processor 12 causing the display device 20 to display the text “Runway 26” and/or by causing the audio device 22 to providing an audible indication, such as by using a speech synthesizer to speak the word “entering Runway 26.” In an especially preferred embodiment, the text “Runway 26” is displayed on the FMS display.

By accessing the coordinates of the current position of the aircraft 26 and the coordinates of the opposite end 60 of the runway 54, the processor 12, using software stored in the memory 14, can calculate the distance between the current position of the aircraft and the end 60 of the runway 54 in real-time and store that distance in the memory device 14. This process step is shown at the block 208 labeled “Determine Distance to End of Runway” (FIG. 5). The calculation of the distance between two sets of coordinates (e.g., longitude and latitude or coordinates corresponding to longitude and latitude) is known in the art, and the software therefor, is within the level of skill of those of ordinary skill in the art, and, therefore, is not set out here. This initial distance between the aircraft 26 and the end 60 of the runway 54, or D_{R}, is stored in the memory device 14. The distance between the aircraft 26 and the end 60 of the runway 54, or D_{R}, is can also be displayed on the display device 20.

It is contemplated that the apparatus 10 is customized for the aircraft in which it is installed and the minimum runway length for that specific type of aircraft, or Dₘᵢₙ, is stored in the memory device 14. Alternately, it is contemplated that in an initial setup routine for the apparatus 10, the type of aircraft is entered into the memory device 14 and the corresponding minimum runway length, or Dₘᵢₙ, is retrieved from a lookup table and stored in the memory 14. Either way, during operation of the apparatus 10, the Dₘᵢₙ for the aircraft 26 is stored in the memory 14. After the apparatus 10 has performed the initial calculation of the distance between the aircraft 26 and the end 60 of the runway 54 to determine D_{R}, the processor 12 compares the distance between the aircraft 26 and the end 60 of the runway 54 to the minimum runway length stored in the memory 14. This process step is shown at the block 210 labeled “Distance to Runway End<Minimum” (FIG. 5). If the distance between the aircraft 26 and the end 60 of the runway 54 is less than the minimum runway length; or D_{R}<Dₘᵢₙ, the processor 12 will provide a visual warning to the flight crew by causing text to be displayed on the display device 20 and/or by providing an audible warning on the audio device 22. The warning may be, for example, the text “Runway Too Short—Abort Takeoff” on the display device 20 or a speech synthesizer may provide the words “Runway Too Short—Abort Takeoff” on the audio device 22. This process step is shown at the block 212 labeled “Provide Warning to Pilot” (FIG. 5). The process is then ended at block 214 labeled “End” (FIG. 5). If the distance between the aircraft 26 and the end 60 of the runway 54 is not less than the minimum runway length, the processor 12 will continue at block 216.

At block 216, the GPS receiver 24 provides the updated coordinates of the aircraft's position to the processor 12. The aircraft's current position, or P_{cur}, is continuously updated and is stored in memory 14 for later use, such as P_{cur1}, P_{cur2}, etc. The time of each of the reading of the current position is also stored in the memory device 14. Thus, P_{cur1} and its corresponding time, or T₁, are stored in the memory device 14 and P_{cur2} and its corresponding time, or T₂, are also stored in the memory device 14. If the aircraft 26 is still positioned at the takeoff position 58, the aircraft's current position, as provided by the GPS receiver 24 to the processor 12, will not change. However, if the aircraft 26 begins its ground-roll, the aircraft's position, as provided by the GPS receiver 24 to the processor 12, will change. In either case, the aircraft's current position is updated at the block 216. This information is stored in the memory 14 for later use.

The coordinates of the opposite end 60 of the runway 54 were previously stored in the memory device 14 from the process at block 206. Thus, by accessing the coordinates of the updated aircraft's current position (P_{cur}) and the coordinates of the opposite end 60 of the runway 54, the processor 12, using software stored in the memory 14, can calculate the distance between the updated current position of the aircraft 26 and the end of the runway in real-time and store that distance (D_{R} or distance remaining) in the memory 14. This process step is shown at the block 218 labeled “Determine Distance to End of Runway” (FIG. 5). As stated above, the calculation of the distance between two sets of coordinates (e.g., longitude and latitude or coordinates corresponding to longitude and latitude) is known in the art, and the software therefor, is within the level of skill of those of ordinary skill in the art, and, therefore, is not set out here. This distance D_{R} is stored in the memory 14 for later use.

The current ground speed of the aircraft 26, or S_{g}, and the current acceleration of the aircraft, or a_{cur}, are calculated from the aircraft position data provided to the processor 12 by the GPS receiver 24, as described above. This process step is shown at the block 220 entitled “Determine Current Speed and Acceleration” (FIG. 5).

The time for the aircraft 26 to reach the end of the runway from its current position, or t_{end}, is calculated based on current ground speed and current acceleration, which can be calculated from coordinate data provided by the GPS receiver 24 to the processor 12, as described above. The time for the aircraft 26 to reach V2 from its current airspeed V2 can be calculated from the equation t_{need}=(V2−Sₐᵢᵣ)/a_{cur}, where Sₐᵢᵣ is the current air speed as provided to the processor 12 from the air speed sensor 36, and a_{cur} is the current acceleration, as computed from the GPS receiver position data, as described above. Both t_{end} and t_{need} are calculated for the aircraft's current position based on coordinate data provided by the GPS receiver 24 to the processor 12, as described above. This process step is shown at the block 222 entitled “Calculate Time to End and Time to V2” (FIG. 5). The values of t_{end} and t_{need} are stored in the memory device 14 for later use.

In order to determine whether the aircraft 26 will reach takeoff speed, V2, before it encounters the end 60 of the runway 54, the processor 12 compares the time to reach the end of the runway to the time necessary to reach takeoff speed. This comparison can be performed by the processor 12 by retrieving the values of t_{need} and t_{end} from the memory 14 and, using appropriate processor instructions, to compare those values. This process is performed at block 224 entitled “Time to End<Time to V2” (FIG. 5). If the time within which the aircraft will reach the end of the runway is less than the time needed for the aircraft to reach V2, i.e.; if t_{end} is less than t_{need}, the process is transferred to block 226.

The time necessary to stop the aircraft 26 at it's current speed, or tₛₜₒₚ, is then calculated by the processor 12, as described above. This process is performed at block 226 entitled “Determine Time to Stop Aircraft” (FIG. 5). The time necessary for the aircraft 26 to stop, or tₛₜₒₚ, is stored in memory 14. The time for the aircraft to reach the end 60 of the runway 54 was calculated in block 222 and stored in the memory device 14. Therefore, the processor 12 retrieves from the memory device 14 the time necessary for the aircraft to stop, or tₛₜₒₚ, and the time for the aircraft to reach the end of the runway, or t_{end}. The processor 12 then compares the time necessary for the aircraft to reach the end of the runway to the time necessary for the aircraft to stop. This process is performed at block 228 entitled “Time to End≦Time to Stop.” If the time necessary for the aircraft to reach the end of the runway is less than or equal to the time necessary for the aircraft to stop; i.e., t_{end}≦tₛₜₒₚ, the process is transferred to block 230. If the time necessary for the aircraft to reach the end of the runway is not less than or equal to the time necessary for the aircraft to stop; i.e., if t_{end} is not less than or equal to t_{need}, the process is transferred to block 216. At block 216, the position of the aircraft is updated and the process steps at blocks 216-228 are repeated.

At block 230, the processor determines if the aircraft 26 has taken off. The weight on wheel sensor 28 provides data to the processor 12. Therefore, if the aircraft 26 has not taken off, there is weight on the wheels and the processor 12 transfers the process from block 230 to block 212. Block 212 provides a warning to the flight crew, such as “Abort Takeoff—Insufficient Runway Length.” If the aircraft 26 has taken off, there is no weight on the wheels and the processor 12 transfers the process from block 230 to block 214, where the process ends.

It is specifically contemplated that in a desired embodiment of the present invention, following the block 224, additional process steps can be provided. Such additional process steps can include detecting the speed of the engines by the engine speed sensor 38 sending data to the processor 12 and/or detecting the throttle position by the throttle position sensor 42 providing data to the processor. Then, if it is determine that the air speed of the aircraft is too low to reach V2 before the end of the runway is reached, the processor 12 can provide a warning to the flight crew, such as text displayed on the display device 20, to increase engine speed, if the engines are not running at full speed.

It is also specifically contemplated that in a desired embodiment of the present invention, the position of the flaps can be used in the calculation of V2. Thus, the flaps position sensor 40 provides data to the processor 12, which can use the data in calculating V2. It is further contemplated that the value of V2 can be updated in real-time, based on the input from one or more of the sensors 30-34 and 40, as the ground-roll of the aircraft 26 is occurring.

It is further contemplated that in a desired embodiment, the distance needed to stop the aircraft can be calculated based on the aircraft's speed. This calculation can be performed based on a formula derived from braking performance data or from a lookup table. It is then further contemplated that a visual or audible warning can be provided in the aircraft if the distance needed to stop the aircraft is less than or equal to the distance between the aircraft and the end of the runway and the aircraft's speed has not reached V1.

It should be understood, of course, that the foregoing relates only to certain disclosed embodiments of the present invention and that numerous modifications or alterations may be made therein without departing from the spirit and scope of the invention as set forth in the appended claims.

1-15. (canceled)

16. A method of providing takeoff runway information comprising:
obtaining an aircraft's coordinates on a runway by a global positioning system (“GPS”) receiver in said aircraft;
retrieving from a database the coordinates for the end of the runway opposite the aircraft;
determining the time for the aircraft to reach the end of the runway based on the coordinates of the end of the runway and the coordinates of the aircraft;
determining the time for the aircraft to achieve takeoff speed; and
providing a visual or audible warning in the aircraft if the time for the aircraft to reach the end of the runway is less than the time for the aircraft to achieve takeoff speed.

17. The method of claim 16, wherein the time for the aircraft to achieve takeoff speed is determined based at least on the speed and acceleration of the aircraft.

18. The method of claim 16, wherein the time for the aircraft to achieve takeoff speed and the time for the aircraft to reach the opposite end of the runway are determined continuously in real time during the aircraft's ground roll.

19. A method comprising:
determining an aircraft's coordinates on a runway by a global positioning system (“GPS”) receiver in said aircraft;
determining the coordinates for the end of the runway opposite the aircraft;
determining the aircraft's speed and acceleration;
determining whether the aircraft will reach the opposite end of the runway before the aircraft reaches takeoff speed; and
providing a visual or audible warning in the aircraft if the aircraft will reach the end of the runway before the aircraft reaches takeoff speed.

20. The method of claim 19, wherein determining whether the aircraft will reach the end of the runway before the aircraft reaches takeoff speed is determined continuously in real time during the aircraft's ground-roll.

21. The method of claim 19, wherein determining whether the aircraft will reach the end of the runway before the aircraft reaches takeoff speed is based on the time for the aircraft to reach takeoff speed and the time for the aircraft to reach the end of the runway.

22. The method of claim 19, wherein determining whether the aircraft will reach the end of the runway before the aircraft reaches takeoff speed is based on the distance needed for the aircraft to reach takeoff speed and the distance between the aircraft and the end of the runway.

23. The method of claim 19, wherein the coordinates for the end of the runway are retrieved from a database.

24. The method of claim 19 further comprising the step of determining the time or distance needed to stop the aircraft based on the aircraft's speed.

25. The method of claim 24 further comprising providing a visual or audible warning in the aircraft if the distance needed to stop the aircraft is greater than or equal to the distance between the aircraft and the opposite end of the runway and the aircraft's speed is less than V1.

26. The method of claim 24 further comprising providing a visual or audible warning in the aircraft if the time needed to stop the aircraft is greater than or equal to the time for the aircraft to reach the opposite end of the runway and the aircraft's speed is less than V1.

27. The method of claim 19, wherein whether the aircraft will reach the opposite end of the runway before the aircraft reaches takeoff speed is determined at least in part based on sensor data for one or more of relative humidity, altitude, exterior ambient temperature, air speed, engine speed, flap position, throttle position or brake application.

28. A method comprising:
using a global positioning system (“GPS”) receiver in an aircraft to determine:
an aircraft's coordinates on a runway, and
the aircraft's speed and acceleration;
determining the coordinates for the end of the runway opposite the aircraft;
determining whether the aircraft will reach the opposite end of the runway before the aircraft reaches takeoff speed; and
providing a visual or audible warning in the aircraft if the aircraft will reach the end of the runway before the aircraft reaches takeoff speed.

29. The method of claim 28, wherein determining the aircraft's coordinates on a runway and the aircraft's speed and acceleration are done continuously in real time during the aircraft's ground roll.

30. The method of claim 29, wherein determining whether the aircraft will reach the opposite end of the runway before the aircraft reaches takeoff speed is done continuously in real time during the aircraft's ground roll.
